(19) United States
(12) Patent Application Publication
(10) Pub. No.: US 2009/0177760 A1
(43) Pub. Date: Jul. 9, 2009

(54) Data Distribution Network

(75) Inventors: George E. Gonzalez, McLean, VA (US); Richard Otis Yeager, Gaithersburg, MD (US)

Correspondence Address: EDELL, SHAPIRO & FINNAN, LLC, 1901 RESEARCH BOULEVARD, SUITE 400, ROCKVILLE, MD, 20850, US

(73) Assignee: Wireless Ventures, Inc., McLean, VA (US)

(21) Appl. No.: 12/348,724

(22) Filed: Jan. 5, 2009

Related U.S. Application Data
(60) Provisional application No. 61/019,066, filed on Jan. 4, 2008.

(51) Int. Cl. G06F 15/16

(52) U.S. Cl. 709/219

(57) ABSTRACT

A data distribution network or system is provided that distributes digital data of any type, but in particular is configured to efficiently distribute digital data for media content titles. The network comprises a data center configured to generate one or more data streams carrying digital media content tiles for transmission to an orbiting satellite transmitter from which a signal containing the one or more data streams is broadcasted. A plurality of subscriber devices are provided, each of which is configured to receive the broadcasted signal from the satellite transmitter and to store digital data associated with a media content title desired by a subscriber device user without immediately presenting the media content title to the subscriber device user.

### CROSS REFERENCE TO RELATED APPLICATIONS

This application claims priority to U.S. Provisional Patent Application No. 61/019,066, filed Jan. 4, 2008, the entirety of which is incorporated herein by reference.

### BACKGROUND

Current direct-to-home (e.g., cable and satellite) media distribution networks use a scheduled-based distribution where digital content (e.g., movies, music, video games, etc.) is transmitted at a particular time over a wide area network (WAN) communication channel. Multiple programs may be multiplexed onto the channel and at a subscriber site a receiver selects one of the programs received over the channel for presentation to a subscriber. Consequently, in these systems the video stream for a particular program is transmitted over the channel at the same rate that it is processed at the subscriber site for presentation to a subscriber. Furthermore, at the subscriber site the video stream is not saved and processed prior to being presented to a subscriber. As a result, any lost packets or other signal degrading problems that occur over the WAN channel to the subscriber are not corrected prior to presentation of the video stream to the subscriber. Except for limited error correction, the subscriber is presented with whatever is received by the subscriber's receiver equipment.

Furthermore, in existing media distribution networks the original media content for a program is compressed in order to reduce the amount of data needed to be transmitted over the channel for a program. This is important in existing media distribution networks because multiple programs are transmitted over the same channel and to make most efficient use of the channel, it is desirable to transmit as many programs as possible. Therefore, when a subscriber receives a program, that program is not the original highest quality version of the program but is a compressed and thus lesser quality version.

Existing media distribution networks transmit over the WAN channel data packets that are completely independent from each other. As a result, only certain error correction codes and algorithms can be used to correct errors that may occur within in one or more packets received at the subscriber site. If one or more data packets are lost in their entirely at a subscriber site, those lost packets cannot be reconstructed and the subscriber will therefore experience degraded presentation of the program.

Yet another shortcoming of current direct-to-home distribution methods is that a program, such as a movie, is only broadcasted or otherwise made available for video-on-demand viewing, after the program has been officially released. This distribution model is inefficient because it is responsive to user selection or demand of a particular title only after that title is officially released. Therefore, the distribution service provider must account for periods of high demand immediately after a title is official released.

There is room for improving the manner in which digital content is distributed to subscriber sites to make more efficient of channel bandwidth and consequently more efficiently deliver the digital content in its highest quality form to users that desire such content.

### SUMMARY

Briefly, a data distribution network or system is provided that distributes digital data of any type, but in particular is configured to efficiently distribute digital data for media content titles. The network comprises a data center configured to generate one or more data streams carrying digital media content tiles for transmission to an orbiting satellite transmitter from which a signal containing the one or more data streams is broadcasted. A plurality of subscriber devices are provided, each of which is configured to receive the broadcasted signal from the satellite transmitter and to store digital data associated with a media content title desired by a subscriber device user without immediately presenting the media content title to the subscriber device user.

### BRIEF DESCRIPTION OF THE DRAWINGS

FIG. 1 is a diagram illustrating impact of signal-to-noise ratio (SNR) in a satellite data distribution network.

FIG. 2 is a block diagram of a satellite data distribution network and illustrating localized weather impact of data distributed to subscriber devices.

FIG. 3 is a block diagram of a data distribution network configured to optimize the deliver of data to subscriber devices.

FIG. 4 is an example of a timing diagram illustrating an example of stages of creating, promoting and delivering digital content to users.

FIG. 5 is a block diagram of a media stream processor at a data center.

FIG. 6 illustrates an example of a frame structure for data in a transmission stream that is transmitted to subscriber devices.

FIG. 7 is an example of a flow chart illustrating how data is encoded and formatted in a transmission stream for transmission to subscriber devices.

FIG. 8 is an example of a block diagram of a subscriber device.

FIG. 9 is an example of a block diagram of a signal processor in the subscriber device.

FIG. 10 is a diagram that depicts a packet reconstruction technique employed in the subscriber device.

FIG. 11 is a diagram illustrating examples of transmission streams containing data for multiple titles.

FIG. 12 is a diagram illustrating an example of an automatic title selection filter that may be programmed by a user to automatically select and have titles delivered to a user's subscriber device.

FIG. 13 is a flow chart illustrating an example of the operations performed at data center from which content is delivered to subscriber devices.

FIG. 14 is a flow chart illustrating an example of the operations performed at a subscriber device.

### DETAILED DESCRIPTION

System Availability

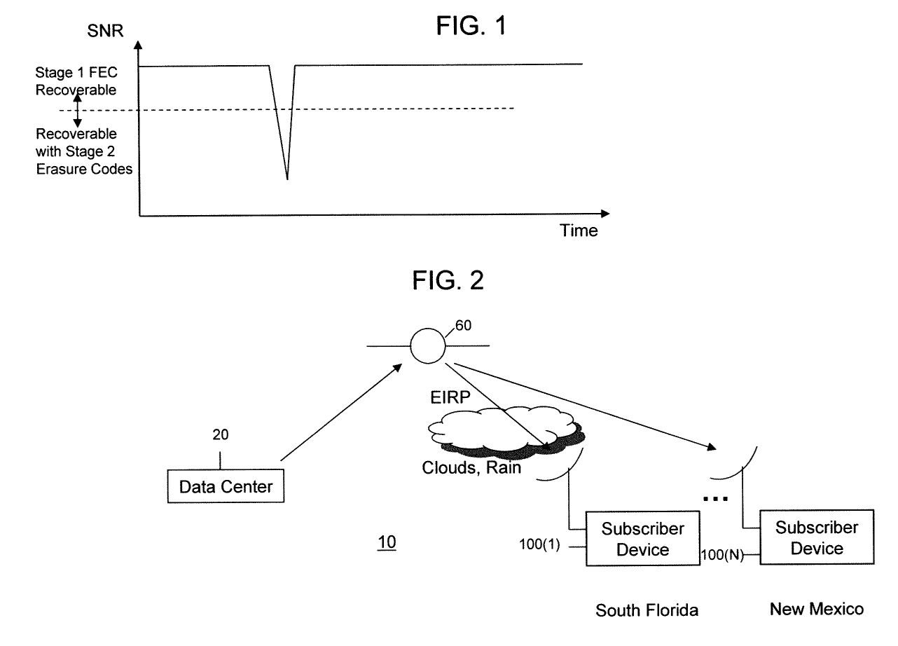

With reference to FIGS. 1 and 2, system availability of a data distribution network is described as a basis for understanding motivations for the data distribution network described herein. FIG. 2 shows a satellite data distribution network 10 comprising a data center 20, an orbiting satellite 60 and a plurality of receiver subscriber devices 100(1)-100(N). In general, a satellite distribution network may be designed to achieve a certain degree of system availability, e.g., 99.99%, that translates to a certain number of minutes per year where service to subscribers is interrupted. The system availability parameter determines the network link budget—how much power is needed to transmit data from a data center location to a worse case subscriber site. The amount of power that the satellite uses to transmit to the worse case subscriber site is referred to in the art as the Effective Isotropic Radiated Power (EIRP).

For example, in the south Florida portion of the United States, there is significant cloud cover and heavy rain during summer months. Thus, the satellite signal transmitted to subscribers in south Florida may be degraded during these time periods. A network that serves subscribers in geographical regions that have signal degrading weather patterns needs to be designed to take into account those worse case subscribers. Another cause of service disruption is solar flares.

The plot shown in FIG. 1 illustrates occurrence of sharp drops in the signal-to-noise ratio (SNR) due to weather, a solar flare, etc. During these periods of times, the affected subscribers experience an outage of service because the subscriber receiver equipment will not be able to demodulate the received signal in order to recover the data when the SNR is very low. It is desirable to be able to fix the situation that occurs when there is an outage of service at a subscriber site so that every subscriber site in the network ultimately receives all of the transmitted data.

More specifically, there is an SNR threshold shown by the dotted line in FIG. 1 above which standard forward error correction (FEC) coding/decoding techniques, referred to herein as Stage 1 FEC encoding/decoding techniques, can be employed to correct for certain bit loss and bit errors in a received transmission. However, below this threshold, the extent of errors caused by such low SNRs is such that standard FEC coding/decoding techniques are not capable of recovering the errors. A system and methodology are described herein to allow for recovering of errors when the SNR at a receiver device drops below this threshold. These error recover techniques are referred to herein as Stage 2 FEC erasure encoding/decoding techniques.

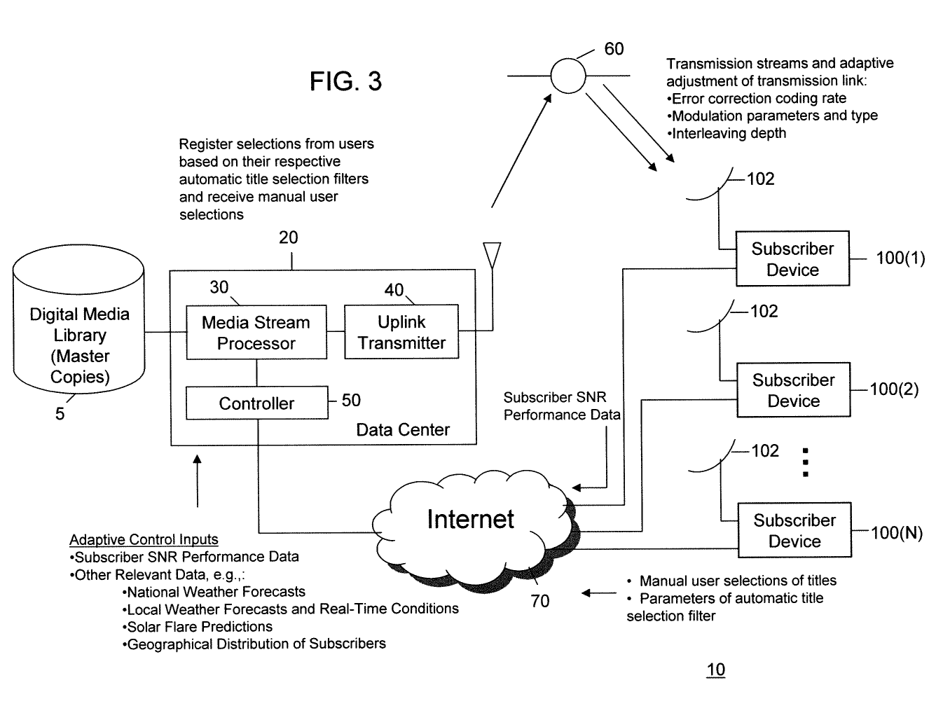

Turning to FIG. 3, an example of a more comprehensive block diagram of the data distribution network 10 is shown. The network 10 comprises the data center 20 that processes the data to be transmitted to subscriber devices 100(1)-100(N). The subscriber devices may be located at homes or at business locations. The data center 20 accesses data files for master copies of digital media assets such as movies, music, educational programs, interactive video games, software program titles, etc., contained in a digital media master library 5. For simplicity, the term “title” is used herein to mean any type of digital media asset, examples of which are movies, television shows, music, software, games, etc.

The data center 20 comprises a media stream processor 30, an uplink transmitter 40 and a controller 50. The media stream processor 30 generates a data stream that is supplied to an uplink transmitter 40 that transmits an uplink signal containing the data stream to a satellite 60. The satellite 60 receives the data stream from the data center 20 and generates downlink transmission streams that the satellite broadcasts to subscriber devices 100(1) to 100(N). At the subscriber devices 100(1)-100(N), the received transmission streams are recovered from the downlink signal and the data files transmitted by the data center 20 are stored for use by a subscriber user. One or more, or all, of the subscriber devices 100(1)-100(N) may also communicate signal reception performance or quality information, e.g., received SNR, to the data center 20 via one or more other wireless and/or wired communication networks generally depicted generally as the Internet at reference numeral 70.

Each of the subscriber devices 100(1) to 100(N) also has a receiver dish antenna 102 that receives the downlink signal from the satellite 60. The satellite 60 may be a standard geosynchronous satellite and the receiver dish antenna 102 may be a standard 60 cm dish antenna known in the art.

One use of the distribution network 10 is to distribute exact copies of data files, whatever the content of the data files, to subscriber devices 100(1)-100(N). The subscriber devices 100(1)-100(N) store the data files for use by subscribers, where “use” may involve playback of a digital video program (movie or other video program), playback of audio programs (music), execution of a digital video game, etc. As such, the transmitted data is not necessarily a real-time media stream that is immediately presented to a subscriber upon its reception by the subscriber device. Rather, processing of the received data packets associated with a data file is made after it is received at the subscriber device and prior to presentation or use by a subscriber. Therefore, the received data need not be perfect upon its reception as is the case in a scheduled-base distribution network. In the network 10, the data can be subsequently reconstructed if necessary as the data is received over time.

According to aspect of the distribution network 10, unlike existing media distribution networks, packets of data that are assembled to transmit a media asset are correlated so that if one or more packets are completely lost during transmission, the lost packets can be reconstructed from data included with other packets that were received. There are many techniques that can be used to build in correlation between packets of data. One technique is to use a coding scheme called “erasure codes”, referred to above as Stage 2 FEC encoding/decoding. Other coding techniques known in the art or hereinafter developed may also be used to build in correlation between packets in the media stream. In general, any coding technique can be used that correlates packets or blocks of data whereby a message of n blocks (packets) of data is transformed into a message with more than n blocks, such that the original message can be recovered from a subset of those n blocks.

Furthermore, because the media content delivered in the network 10 is post-processed at a subscriber device before it is even stored (and thus before it is presented to the user, i.e., it is not intended for immediate presentation to a user), the transmission rate of the data can be made to be faster than the so-called “playout” rate by the subscriber device. When and if errors occur in the received data that cannot be corrected by Stage 1 FEC decoding techniques, those errors can be corrected using the non-real-time Stage 2 FEC decoding techniques. (The Stage 2 FEC (erasure coding) techniques cannot be used for correcting errors in a transmission stream that is intended for immediate presentation to a user due to the processing requirements of erasure decoding schemes.) If the Stage 2 FEC decoding techniques cannot fix the error or reconstruct missing packets, then the missing packets can be received during the next transmission interval for that particular title. Again, because the titles are distributed for storage and not for immediate presentation, the user experiences little to no impact for the delay in waiting for the next transmission interval for a particular title if the packets could not otherwise be corrected or reconstructed using the Stage 2 FEC decoding techniques.

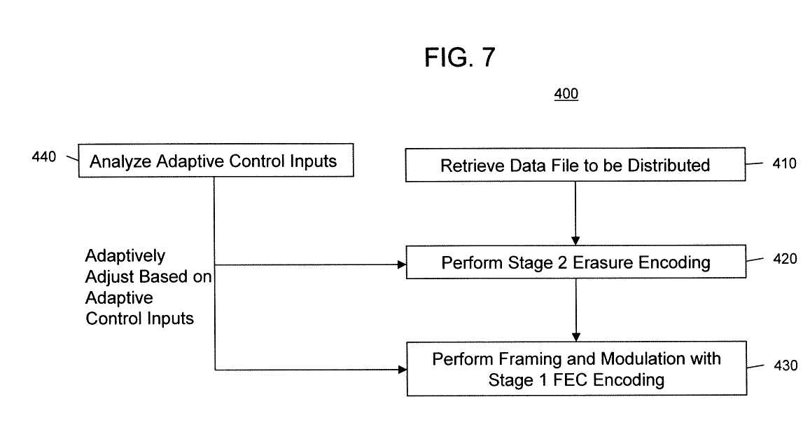

According to still another aspect of the distribution network 10, the data center adaptively adjusts parameters associated with the transmission streams that the satellite 60 broadcasts to subscriber devices 100(1)-100(N). The control inputs to this adaptive transmission adjustment scheme include SNR measurements made at individual ones of the subscriber devices 100(1)-100(N) as explained above, as well as other relevant data, e.g., national weather forecasts, local weather forecasts and real-time weather conditions, solar flare predictions, and factors such as geographical density/distribution of subscribers. Through the SNR measurements made by subscriber devices 100(1)-100(N), the subscriber devices 100(1)-100(N) serve as rather sophisticated weather tracking network because SNR measurements are primary due to weather conditions at or near a subscriber device location. Examples of transmission stream parameters that may be adjusted include the error correction coding rate, modulation parameters (depth) and type, interleaving depth in a transmission frame, etc. A further explanation of the adaptive transmission adjustment scheme is described hereinafter in conjunction with FIG. 7. In sum, the goal of the adaptive transmission adjustment scheme is to continuously optimize the transmission streams for delivery of data to subscriber devices.

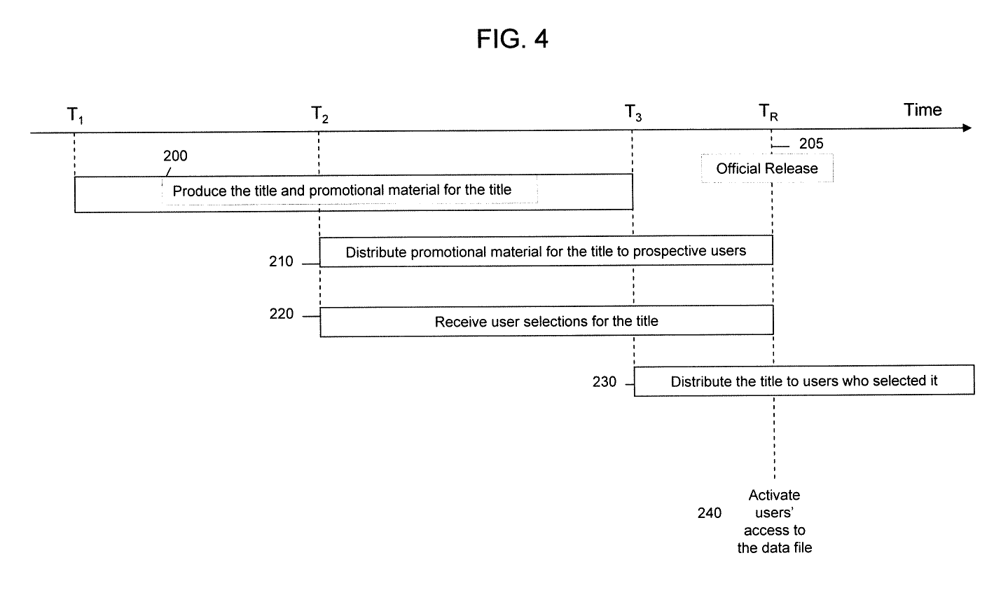

Turning now to FIG. 4 in which a timeline is illustrated for a media distribution technique that exploits the fact that the data to be distributed is not for immediate presentation to a user. Furthermore, this media distribution technique need not be constrained to a schedule whereby there is a time interval during the day for “prime-time” viewing. Rather, every minute of the day can be allocated equal “value” for purposes of allocating bandwidth to transmit content to subscriber devices. Moreover, if desired, priority may be placed on distributing a particular title (over other titles) by the data center, but such priority need not be tied to a programming schedule per se.

Users of subscriber devices make selections of titles either manually or through user configuration of a title selection filter. The data center 20 registers selections made by users from their manual selections or title selection filters.

FIG. 4 illustrates a timeline that represents a “theatrical production and release” model for movies and other entertainment, such as television shows. A title, such as a movie, is produced at 200. Production of a movie can take several months up to several years depending on the complexity of the scenes of the movie, etc. For the sake of this example, production of the title begins at time T₁. Once production of the movie is completed, it is then given an official release date which is shown at 205 and occurs at time T_{R}. A title may be released first for distribution in movie theatres and subsequently released for distribution to homes. For purposes of this description, the release date shown at 205 is a distribution-to-home (DTH) release date because the network 10 described herein takes advantage of user-specific selections of titles in advance of the DTH release date. Other types of titles, such as music and video games, may have only one release date.

At some point during production of the title at 200, promotional material is produced for the title. The promotional material is supplied to the library 5 (FIG. 3) for distribution by the data center 20 as shown at 210 at time T₂. For example, a “trailer” is created for the title and the data center 20 distributes this to all subscribers in the network 10 (i.e., “prospective users” of the title). The title may be music, video games, etc., and suitable promotional material is created for distribution to prospective buyers.

Once the data center 20 has begun delivering promotional material for a particular title, the data center may also begin to receive user selections for the title at 220 at time T₂. As shown in FIG. 2, the data center can receive user selections for the title long before production of the title is even completed. These user selections may be manual user selections or selections based on the automated title selection filter programmed by a user.

Once production of the title is complete, a digital master copy of the title can be supplied to the library 5 (FIG. 1) at time T₃, or at any time thereafter. Thus, at time T₃, the data center may 20 may begin distributing the full digital master copy of the title to the subscriber devices of users who have selected it for purchase or rental as shown at 230. As shown by the timeline in FIG. 2, time T₃ is well before the official release date 205 of the title and therefore the data center 20 can begin distributing the title to subscriber devices long before even the official release date 205. The subscriber devices for users that have expressed interest in a title either manually or via automatic filtering will store the title data file in a storage unit, e.g., hard drive, of the subscriber device. The user's subscriber device stores the data file for the title well before the official release date, but the user cannot access and use the data file until the official release date. To this end, the data center 20 may use any of a variety of digital rights management (DRM) techniques now known or hereinafter developed to prevent access and usage of the title until the official release date.

Once the date of the official release 205 arrives at time T_{R}, access to the data file stored in the subscriber devices (of users that purchased rights to the title) is activated at 240. However, precisely at time T_{R} (to the minute), users who have purchased rights to the title and already have the title stored in their subscriber devices can begin using the title. In this way, the service provider entity that operates the network 10 can comply with the contractual obligations of the content providers (e.g., movie studios, music label companies, game creators, etc.) by ensuring that users cannot access and use the title before the official release date even though the data file for the title has been stored in a subscriber device long before the release date.

The distribution network 10 and methods described herein permit a much more efficient distribution of digital content to users than any techniques heretofore known. While current distribution techniques rely on responding to user requests after a title has been released for distribution, the techniques described herein promote the title before it is released and determine which users want to purchase that title. Because the digital data for the title can be distributed to users that purchase or express interest in the title before the title is official released, the data center 20 can spread the burden or load of distributing a particular title over time. For example, the data center 20 can begin putting data for the title in the stream that it broadcasts to subscriber devices as soon as time T₃ in order to get the title to the early purchase users. Thus, distribution of the title can be spread over a period of time that begins at time T₃, and not at time T_{R} as is currently done in media distribution models. In a network where bandwidth and usage of the bandwidth affects a service provider's revenue, the techniques described herein allow a service provider to optimize network channel capacity and thereby increase revenue.

Moreover, a user of a subscriber device can create and build a personal library of titles over time. The user need not wait until a title is officially released to purchase and acquire the title. Using the techniques described herein, the user can indicate his/her desire to purchase the title, and the title will be received and stored in the user's subscriber device well before official release, ready for access by the user at the moment that the title is official released. In essence, the user experiences instantaneous access to a title upon its official release without requiring the user to take any further action to order the title and without burdening distribution channel with a surge of high demand for titles on their official release date.

Further still, a subscriber device stores a personal library of virtual master copies of a title. One advantage of spreading over time the burden of transmitting titles to users is that a high quality version (and thus larger size data file) of the title can be distributed to users. In particular, the data center 20 can distribute the same data file for the digital master copy of the title in the highest resolution available for that title, and the subscriber devices store that master copy. For example, if the title is a digital video disk (DVD) quality movie, then a virtual DVD copy of the title is distributed to users. This is a significant advantage over current media distribution networks (cable and satellite) which broadcast content that has been converted to a format suitable for the bandwidth available on that network. In these prior art systems, the data is in a format intended for immediate presentation without any significant correction or processing, and not for permanent storage. The resolution quality of the title is much less than the digital master copy of the title. The user therefore experiences a much lower quality version of the title than is otherwise available.

It should be understood that while the foregoing description with reference to FIG. 4 emphasizes that the data for a title can be distributed before its official release date, this is only by way of example to illustrate one of the advantages of the distribution schemes described herein, but it is not meant to be limiting. The network 10 also distributes data for titles after their official release dates.

Furthermore, for purposes of this description, users do not necessarily have to “purchase” a title in order to receive it. Instead if a user expresses interest either manually or via a match in their automated filter, then the title will be provided and stored in the user's personal library. Once the title is made available to the use, he/she will then have the opportunity to purchase or rent the title for presentation.

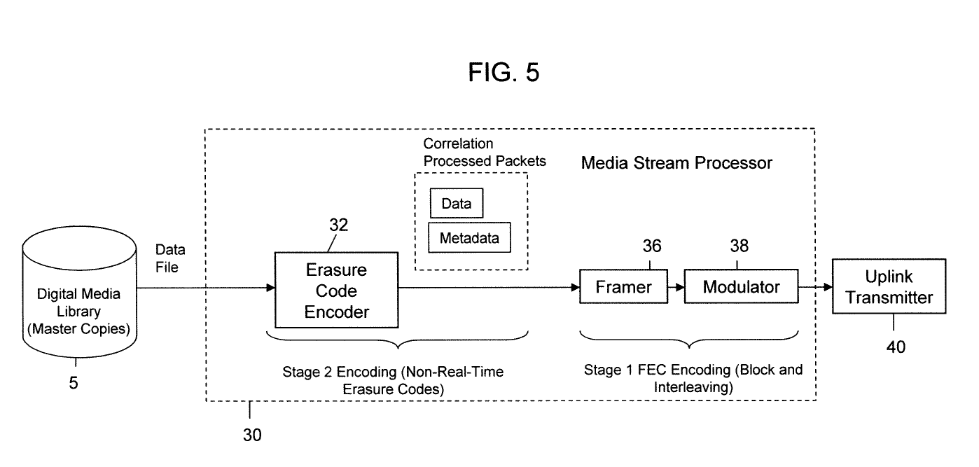

Reference is now made to FIG. 5 for a more detailed description of the media stream processor 30 shown in FIG. 3. The media stream processor 30 takes a data file for a media asset and generates a stream of data packets that represents the data file for modulation and transmission up to the satellite. To this end, the media stream processor 30 comprises an erasure code encoder 32, a framer 36 and a modulator 38. It should be understood that the one or more of the components of the media stream processor 30 may be embodied by computer software executed by one more computers or may be embodied as application specific integrated circuit (ASIC) hardware accelerators used by a computer. Since the data center 20 is not limited to electrical power and computer power constraints that are associated with mobile or portable devices, there is no limit on the degree of computing power that may be used for the media stream processing functions.

The erasure code encoder 32 performs the aforementioned Stage 2 (non-real-time) erasure code encoding. The combination of the framer 36 and modulator 38 perform framing and modulation functions and in the course of doing so perform the aforementioned Stage 1 FEC Encoding.

The erasure code encoder 32 analyzes the original data file and generates a sequence of correlated data packets, referred to herein as correlation-processed packets (CPPs), where each CPP comprises a data component and a metadata component. The metadata component comprises information about other data packets that can be used to reconstruct the other data packets, if necessary.

The erasure code encoder 32 may also perform FEC coding, such as by using a so-called “turbo code”, to encode error correction into each CPP. The FEC encoding allows for bits within a received CPP to be corrected at the subscriber device.

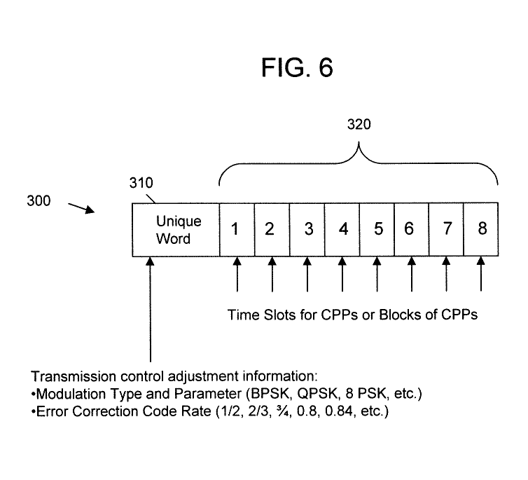

Next, the framer 36 takes the output of the erasure code encoder 32 and builds a frame that comprises CPPs as well as various control information. FIG. 6 illustrates an example of a frame 300. It should be understood that numerous frame structures may be suitable. The frame 300 comprises a unique word field 310 whose unique pattern permits the Subscriber Device to deduce that contains information about the frame and a data field 320 comprising several time slots each for CPPs or blocks of CPPs. The number of time slots in frame may vary. For example, and not by way of limitation, there are 8 time slots in the data field of the frame shown in FIG. 5.

The CPPs that occupy time slots of a data field for a particular frame need not be for the same title. For example, a particular frame may contain CPPs in the data field as follows:

| Title | Time Slots |
|---|---|
| Title 1 | 1, 3, 5 |
| Title 2 | 2, 4, 6 |
| Title 3 | 7, 8 |

Thus, CPPs for different titles may be included within a frame, and furthermore the packets for different titles may be interleaved with packets from other titles within a frame. It is also possible to interleave CPPs for Z different titles within a frame, where Z is the number of time slots in the data field for that frame. In addition, CPP data may be interleaved from one frame to the next frame such that no consecutive frames contain data from the same title. By interleaving packets from multiple titles in this manner, the number of packets lost in a transmitted media stream for a particular title as a result of a sharp drop in SNR at a receiver is greatly reduced.

In the unique word field 310, subscriber devices can deduce information from the encoded pattern that represents the transmission control adjustment information associated with that frame. As explained above, the data center 20 may continuously change one or more transmission stream parameters in order to optimize delivery of data in the network 10. Accordingly, different unique word fields may be encoded to represent the modulation type and modulation parameter (depth) employed for the packets as well as the FEC rate applied to the packets in a frame.

The modulator 38 performs the baseband modulation on the frames using any one of a variety of baseband modulation schemes such as binary phase shift keying (BPSK), quadrature phase shift keying (QPSK), 8PSK, etc., and also applies the aforementioned Stage 1 FEC encoding in the course or generating the frames. The modulated frame is then supplied to the uplink transmitter 40 that upconverts the modulated frame onto a radio frequency (RF) carrier signal that is transmitted to the satellite 60.

The data transport system described in the foregoing is very resilient to packet errors and lost packets. Different subscriber devices may lose different packets from their received transmission streams. However, each subscriber device is capable of reconstructing whichever packets may have been lost. Moreover, if for some reason a subscriber device does not have enough information from correct received packets to reconstruct lost packets, the subscriber device will store an indication of the lost packet(s) so that the next time that the data file is transmitted from the satellite, the subscriber device will receive and capture the one or more lost packets.

FIG. 7 illustrates a flow chart for a process 400 performed by the media stream processor 30 to generate a frame for transmission in a transmission stream, and to this end, the flow chart shown in FIG. 7 summarizes the functions of the media stream processor described above in conjunction with FIG. 6. At 410, a data file to be distributed is retrieved from the media library 5 and at 420, packets of the data file are encoded according to the aforementioned Stage 2 erasure coding techniques. At 430, the encoded packets are modulated and grouped into a frames, and in the course of the modulation/framing function 430, Stage 1 FEC encoding is performed.

Furthermore, the parameters of the encoding function performed at 420 and modulation/framing function performed at 430 are continuously adjusted based on the adaptive control inputs as indicated at 440 in FIG. 7.

As explained above, the data center may adaptively and dynamically adjust parameters of the transmitted data based on actual subscriber performance data and based on other information that may impact the ability of a subscriber device to receive the data. For purposes of the description of this aspect of the distribution network, reference is made again to FIG. 1, with continued reference to FIG. 7. As shown in FIG. 1, the controller 50 at the data center 20 comprises a processor 52 (e.g., a computer that executes one or more computer programs) that stores updated adaptive control input data and executes an adaptive transmission scheme. The adaptive control input data may comprise one or more of:

Subscriber SNR Performance Data From Subscribers in Various Geographical Regions (e.g., Miami, Atlanta, Chicago)

Global and Regional Weather Forecasts

Local Weather Forecasts and Real-Time Weather Conditions

Solar Flare Predictions

Geographical Distribution of Subscribers in the Network

The controller 50 is configured (through one or more software programs) to use the adaptive control input data to plan and implement adjustments according to predicted or expected degraded performance at certain subscriber sites and may immediately react to actual degraded performance data supplied from one or more subscriber sites. Actual degraded performance data may comprise real-time subscriber SNR performance data reported back to the data center 20. Predicted or expected degraded subscriber performance may be determined from global and regional weather forecasts in which a particular geographical region may be predicted to experience rain, severe cloud cover or other weather conditions that may degrade subscriber SNR performance. National weather forecast data may be retrieved from one or more weather data sources (e.g., National Oceanic and Atmospheric Administration in the Untied States) and stored at the controller 50 for use in scheduling adaptive control adjustments. Likewise, expected or degraded performance may be even more precisely predicted from local weather forecasts (a particular city or region around a city). Real-time weather conditions at a local level are also retrievable from government-run weather reporting systems and may be used as more precise indicators of expected or actual degraded performance in a particular geographical area. Further still, solar flare prediction data, which is made available by many government and other agencies around the world (e.g., National Aeronautics and Space Administration (NASA) in the United States), may be used to predict when a solar flare will occur causing degraded performance to subscriber sites across even larger portions of a network coverage area.

The outputs of the controller 50 comprise adjustments to one or more of: degree of packet correlation used erasure code encoder 32 during the Stage 2 erasure encoding at 420, the FEC coding rate used for the CPPs produced in the course of the erasure encoding process by the erasure encoder 32, interleaving depth by the framer 36, and modulation type/rate as well as Stage 1 FEC rate used by the modulator 38 at 430.

The coding used by the erasure code encoder 32 in generating the CPPs may be adjusted to improve the likelihood that lost packets can be corrected at subscriber devices. As the correlation coding rate is lowered, a higher degree of correlation is encoded into the data thereby reducing the amount of data included in a stream of CPPs in exchange for a greater ability to reconstruct lost packets. A higher correlation coding rate is used when concern for reconstructing lost packets is reduced, allowing for more data to be included in the CPPs.

Similarly, the code rate of the FEC used by the erasure code encoder 32 may be adjusted in order to improve the likelihood that bit errors in received CPPs can be corrected. The FEC rate may be slowed down during periods of time when it is desired to improve the likelihood that subscriber devices will be able to correct for bit errors as a result of a lower SNR at subscriber devices. On the other hand, when the transmission channel is such that subscriber devices have higher SNR levels, the FEC rate can be increased thereby increasing the amount of data included in the transmission.

Interleaving depth of CPPs for different titles may be adjusted to minimize the number of lost packets that subscriber devices may experience from lower SNR conditions. For example, during a period of time, the transmission may include packets interleaved from numerous titles to compensate for lower SNR conditions at subscriber devices. This will lower the overall data throughput to subscriber devices for given title, but reduces the likelihood of lost packets for any given title. On the other hand, when SNR conditions at subscriber devices are higher, the depth of interleaving can be reduced such that packets from a smaller number of titles are interleaved, thereby increasing the data throughput for a given title.

Finally, the modulation type (and parameters for a particular type of modulation) may also be adjusted according to expected or actual performance at subscriber sites. The controller 50 may select a certain (slower) modulation type and data rate that is better suited for the conditions causing or expecting to be causing the degraded SNR performance in order to reduce the number of lost packets at those subscriber devices. When the period of time during which the actual or expected degraded performance has passed, the controller 50 can switch back to a faster modulation type/data rate.

For example, there may be an SNR continuum such that when the SNR is above a certain level at one or more subscriber device locations of interest, the data center 20 can select a relatively high encoding modulation scheme, e.g., eight phase shift keying (PSK), and a relatively fast coding rate as the SNR is further above this level. Conversely, when the SNR at one or more subscriber device locations of interest is less than a certain level, the data center may select a lower encoding modulation scheme, e.g., quadrature phase shift keying (QPSK) with a relatively slow coding rate as the SNR is further below this level.

As explained above in connection with FIG. 3, certain subscriber devices 100 may be connected via the Internet to the data center 20 in order to periodically (or on demand) send SNR performance data to the controller 50 at the data center 20. Each subscriber device 100 has the ability to capture SNR data concerning the signal it receives from the satellite and to send a message containing the SNR data to the data center 20 via the Internet. The controller 50 stores the SNR data from reporting subscriber devices in the database 52 together with an indication of the geographical location of that source subscriber device and a timestamp associated with the SNR data that is reported. For example, one or more subscriber devices in certain worse case geographical locations (e.g., Miami) may be used to send SNR performance data to the controller 50. In addition, one or more subscriber devices in other geographical locations are also designated to send SNR performance data to the controller 50. It may be desirable to select one or more subscriber devices in each of the major markets where there are high concentrations of subscribers in the network, as well as subscribers in other geographical areas, to monitor performance at subscriber sites throughout the entire coverage area of the network.

The controller 50 may also store data concerning the geographical distribution of subscribers in a coverage area of the network. For example, during a period of time, there may be a substantial number of subscribers in the network that are located in a particular region, e.g., south Florida in the United States. When subscribers in this particular region are experiencing degraded SNR performance, the impact is felt by a large number of subscribers as compared to other geographical areas in the network coverage area. As a result, the controller 50 may be programmed to account for the geographical distribution of subscribers in order to make adjustments to the transmission to minimize the impact on the greatest number of subscribers in the network during a given time period. For example, the controller 50 may slow down the modulation rate and/or reduce the error correction code rate in order reduce the number of bit errors and/or lost packets to the affected subscribers. This adjustment will of course affect all subscribers in the network. Consequently, it will have the side effect of slowing down the transmission of data to those subscribers that are not located in that particular geographical region. But the network operator may make a business decision and choose to make this adjustment anyhow because in order to accommodate a larger percentage of subscribers in the network. The adjustment will be necessary for a relatively short period of time after which the controller 50 can resume normal (faster) modulation data rates and/or error correction code rates. Of course, the opposite scenario may arise where a relatively small number of subscribers may experience degraded SNR performance when the majority of subscribers in the network are not. The network operator may decide to leave the parameters of the transmissions at normal (higher data rate) levels to the temporary detriment of a relatively small number of subscribers.

When changes are made to any one or more of the erasure coding, error correction encoding, interleaving depth and modulation, the controller 50 includes information describing those adjustments in a control field of a frame as shown in FIG. 6. That is, a portion of every frame or in frames, transmitted to subscribers includes at least one field reserved for control and administrative information to inform the subscriber devices about changes to parameters of the transmitted data stream. The subscriber devices recover this control information from received frames and make adjustments in their processing of the received frames in order to track changes in the transmission during the period of time of the adjustments. The controller 50 includes in this control field information describing the transmission adjustments as well as information concerning the start and stop times of the transmission adjustments so that the subscriber devices know when to switch back to standard or other demodulation and/or error correction decoding parameters. Moreover, the coding used for the control information may be one that is higher than the coding used for the time slots of CPPs to ensure that all of the subscriber units receive the control information even in low SNR conditions and can respond accordingly to changes in the transmission.

Thus, when weather conditions are clear, the data center 20 shifts up to faster data rate parameters (less correlation encoding, higher error correction code rates, less interleaving and higher modulation rates) in the transmission to subscribers in order to offset for time periods when the data center had to shift down to slower data rate parameters in the transmission. As a result of this operation, the data center 20 is able to distribute data to subscribers with an overall data throughput rate that is much higher than data distribution networks heretofore known. In particular, each title is transmitted at a data rate that is substantially rate than the presentation (playback) rate at the subscriber sites.

When the data center 20 makes temporary changes to the transmission to the temporary detriment of some subscribers, the changes do not affect the presentation of data to the subscriber. Recall from the foregoing description that the transmitted data packets are processed and then stored in a subscriber device for presentation. Therefore, the real or actual negative impact to a subscriber resulting from changes to the transmission is negligible because the data is not a real-time data stream intended for immediate presentation to the subscriber. Instead, the data files that are distributed to subscribers are intended to be downloaded in their entirety to a subscriber device and then subsequently accessed from local storage in the subscriber device for presentation or use by a subscriber. Consequently, the subscriber in the network will not experience any impact in usage of a data file due to the temporary changes in parameters of a transmission to the subscriber device.

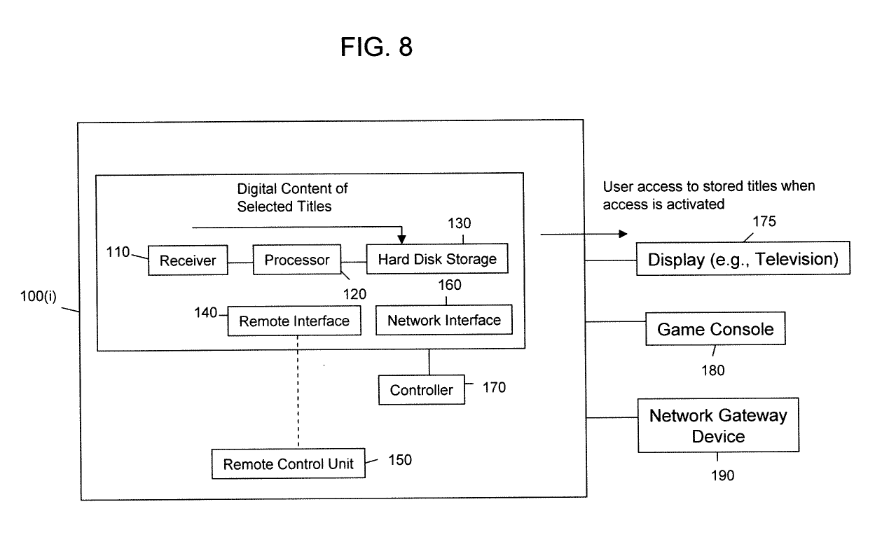

FIG. 8 shows an example of a block diagram of a subscriber device 100(i). This block diagram is simplified to illustrate those aspects of a subscriber device that 100(i) are relevant to the concepts described herein. It should be understood that there are other components and/or specific functions of the subscriber device that are omitted for purposes of the description. The subscriber device 100 comprises a radio frequency (RF) receiver 110, a processor 120, a hard disk storage 130, a remote interface 140, a remote control unit 150, a network interface 160 and a main controller 170. The remote control unit 150 communicates, such as by infrared (IR) and/or other wireless technique, with the remote interface 140 to allow a user to enter commands to operate the subscriber device 100(i). The subscriber device 100(i) is configured to connect to any one or more of a variety of peripheral devices, such as a display or television 175 and a game console 180. In addition, the subscriber device 100(i) may be configured to connect via the network interface 160 to a network gateway device 190 that, in turn, is connected to a local area network as well as to a wide area network, e.g., the Internet. To this end, the subscriber device 100(i) may function as a “media server” within a subscriber device location, to deliver media content stored in the hard disk storage 130 to any of one or more remote user devices, e.g., televisions, personal computers, etc., for presentation to a user.

The receiver 110 receives signals containing data that originate at the data center 20 and relayed by the satellite 60 for example to produce a baseband signal. The processor 120 processes the baseband signal to recover the digital data for storage in the hard disk storage unit 130. The processor 120 may be any microprocessor now known or hereinafter developed that has suitable processing capability for the baseband demodulation, data recovery, video signal processing, audio signal processing, and other functions performed by the subscriber device 100. It should be understood that the processor 120 may be implemented by one or more ASICs, but for simplicity a single block is used to represent the processor 120 and its functions in FIG. 8. The controller 170 is responsive to commands received from the remote control to control the various functions of the subscriber device 100(i). In particular, a user may make a manual selection of a title via the remote control unit 150, and user may also program the criteria for the automatic title selection filter to be used by the data center in automatically distributed titles to a subscriber device for a particular user.

When a user desires to access and use a title stored in the hard disk storage 130, the user may enter a command or select a button on the remote control unit 150 that causes the controller 170 to retrieve the data for that title from the hard disk storage 130 for presentation to a user on the display/television 175, for example. Alternatively, if the title is a game, the controller 170 may transfer the digital data for the game to the game console 180, where the game console 180 processes the game digital data for use by a user. The hard disk storage 130 serves to store a library of titles for one or more users that have access to use a particular subscriber device 100(i).

When digital data is stored in the hard disk storage 130 for titles whose official release data has not yet arrived, the controller 170 prevents access to the digital data for that title using any of a variety of DRM techniques referred to above. Once the official release date for the title arrives, the controller 170 will make the digital data for that title accessible for use by the user.

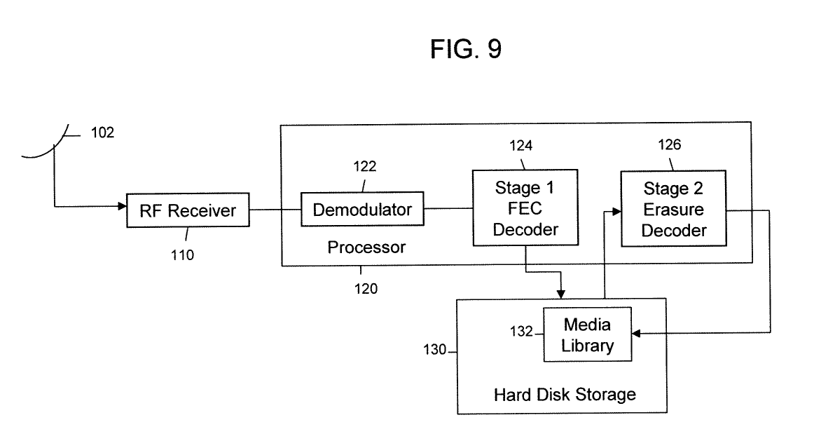

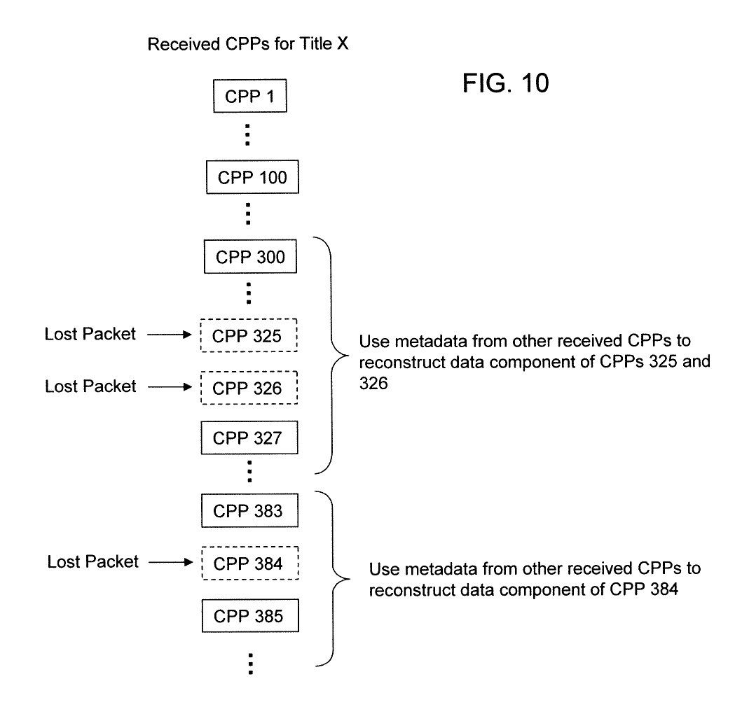

Referring now to FIG. 9, a more detailed block diagram of the processor 120 is described. The processor 120 performs the signal processing of the received transmission stream(s) in order to recover the data carried in the transmission stream. To this end, the processor 120 comprises a demodulator 122, a Stage 1 FEC decoder 124 and a Stage 2 erasure decoder 126. The demodulator 122 is configured to demodulate the modulated signal contained in the received transmission stream according to the type of modulation scheme employed, and to extract bits from received frames. The Stage 1 FEC decoder 124 performs FEC decoding of bits, correcting errors as necessary, to build packets of media content titles, e.g., video packets. The Stage 2 erasure decoder 126 performs any necessary packet reconstruction for any packets that may have been lost during the transmission from the satellite to the subscriber device. The output of the Stage 1 FEC decoder 124 may be stored in the hard disk storage 130 prior to populating a media library 132. To the extend packets for a title need to be reconstructed by the Stage 2 erasure decoder 126, the Stage 2 erasure decoder will retrieve other packets for that title from the hard disk storage 130, perform the necessary packet reconstruction (explained hereinafter in connection with FIG. 10), and then store in the media library 132 the packets for the title. In this way, the media library 132 may be populated with the complete data set for “complete” titles.

Turning to FIG. 10, an example is described of how the erasure decoder 126 may reconstruct missing or lost video packets associated with a title. In this example, the packets, i.e., CPPs, for a particular title are enumerated beginning with CPP1, and after reception of numerous CPPs, the processor 120 in the subscriber device determines that CPPs 325, 326 and 384 are lost or missing. Since the CPPs were encoded using the erasure coding techniques at the data center, the correlation among the patents allows the subscriber device to use the meta data obtained from other received packets to reconstruct the lost or missing packets. Thus, the subscriber device in the example of FIG. 10 can reconstruct CPPs 325, 326 and 384 using the meta data from other received CPPs. As explained above, the fact that the reconstruction of these missing packets may take some amount of time, the user is not aware of any delay or reduced performance because the data for the title is not intended for immediate and real-time (streaming) presentation to a user. In the event that there are one or more packets for a title that cannot be reconstructed even with the erasure decoding techniques, then the one or more missing packets can be obtained during the next received transmission of the data for that title. Again, this still does not impact the user because the title is not distributed for immediate presentation to the user; rather it is distributed for local storage at the subscriber device for subsequent presentation to a user.

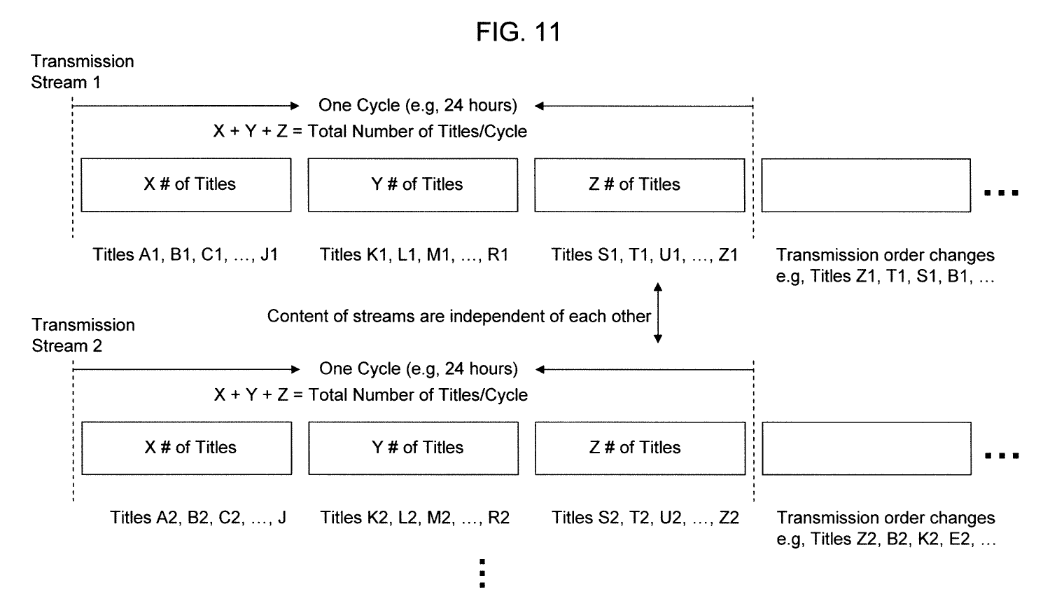

Referring now to FIG. 11, an example of a timing plan for transmissions is shown. One satellite may have the ability to transmit multiple (e.g., 30) signal streams to subscriber stations. During a given time period or cycle, a transmission stream may contain data for a certain number of titles. For example, a cycle may comprise 24 hours. Each transmission stream may contain content that is independent of the content in other streams. That is, transmission stream 1 may contain data for different titles than the titles contained in transmission stream 2 as indicated in FIG. 11. The content in a transmission stream may be replaced by different content after a certain number of cycles.

Furthermore, the order of transmission of titles during one cycle may be different during the next cycle. There is time-diversity with respect to the transmission of data files for titles. If a subscriber in a particular geographical region experiences severe cloud cover or rain at the same time every day, the subscriber device may be losing packets in transmission streams every day during that time interval. However, the transmission stream will not necessary contain the same titles during that time interval so that packets from the same title could be lost. This increases the probability that the data file for a title desired by a subscriber will be received and stored in the subscriber device as soon as possible.

Each subscriber device effectively serves as a library that subscribers may populate with titles they elected to purchase or rent. The title that is delivered to a subscriber device is an exact duplicate of the master data file transmitted by the data center. Thus, the distribution network described herein can be viewed as a distribution network for “virtual” data files of content, i.e., “virtual DVDs”, “virtual CDs”, “virtual video games,” etc. Thus, rather than a user visiting a movie rental store or subscribing to a mail-based movie rental service, a subscriber to the distribution network has access to the same type of content without leaving their home. Furthermore, once the content has been stored in a subscriber device, the subscriber may use the content at any time without the need to return it to a store or mail-based service within a certain time period.

A subscriber device is continuously receiving transmission streams 24 hours a day and can download titles desired by the subscriber during the day and overnight even when the subscriber is not present or otherwise using the subscriber device. It may take several hours for the subscriber device to receive the desired content contained in a transmission stream, but this is still faster and more convenient than having to go to a movie rental store or receive a move from a mail-based movie rental service. In the unlikely event that the first time a subscriber device received the data file for a title the subscriber device could not receive one or more data packets and could not reconstruct the data packets from the metadata of received packets, the subscriber device stores an indication of those particular data packets. The next time (e.g., the next cycle) the data file for that title is transmitted in a transmission stream the subscriber device will receive and store those data packets to make the stored data file for that title a complete and exact copy of the data file at the data center. The probability of a subscriber experience an “outage” in which a portion of the title is missing is nearly impossible because the entire data file will inevitably be received by the subscriber device before the subscriber will want to access and use that title.

Using the distribution network described herein, the network operator can include a data file for a movie trailer as soon as the move trailer is released by the movie studio during the theatrical release period. Thus, a particular title can be directly marketed to subscribers. The network operator can also include information as to the studio release date of the title. A subscriber can then indicate his/her desire for that title and the subscriber device will automatically receive the data file for that title for storage in the subscriber device. The subscriber device may receive the data file while the subscriber is not home (e.g., at work) or in the middle of the night, and populating the subscriber's local library with the title. Even when the subscriber is not accessing and using content in the subscriber device, the subscriber device is working constantly and continuously 24 hours a day receiving transmission streams and the distribution network takes advantage of this fact to enable the subscriber device to continuously populate the library based on the subscriber's subscription level, etc. When the subscriber returns to the subscriber device (i.e., the next morning), the titles will already be stored in the subscriber device ready for use by the subscriber as if the subscriber had gone out and purchased or rented the title himself/herself.

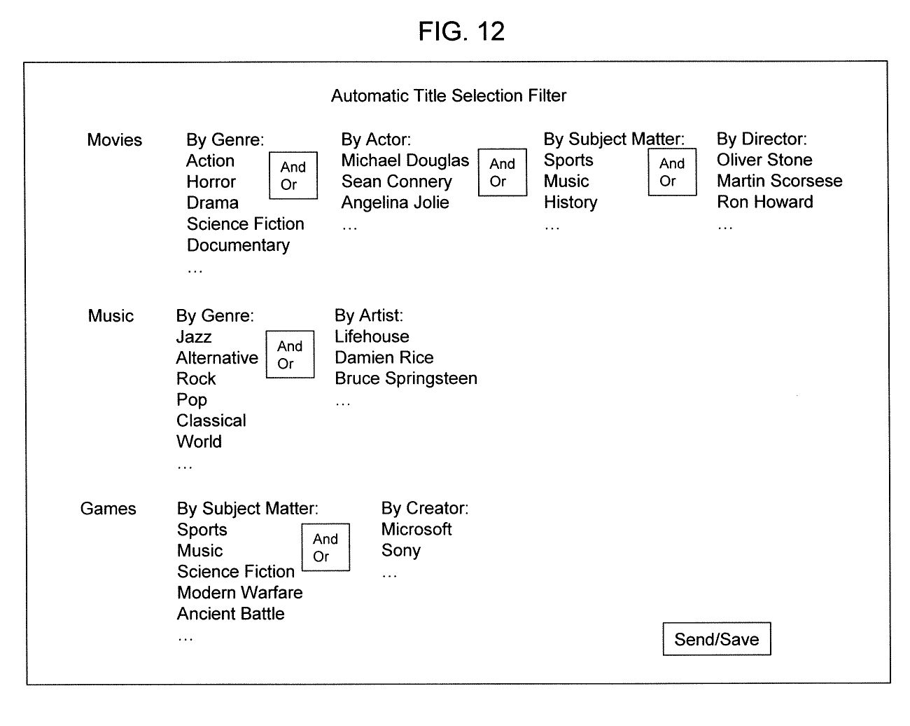

FIG. 12 illustrates an example of parameters that a user can set in his/her automatic title selection filter. A graphical user interface may be created for display on a display or television screen connected to the subscriber device to enable a user to program the title selection filter using a remote control unit associated with the subscriber device. Alternatively, the user may log into his/her account maintained by a service provider's web site to set the parameters of his/her automatic selection filter. Examples of parameters for automatic selection of movie titles may comprise Genre, Actor, Subject Matter and Director. Each of these parameters may be “And'ed” together or “Or'ed” together. In this example, a user may select one or more Genre types (Action, Horror, Drama, etc.). A user may also enter the name, or select from a drop down list of names, of one or more actors in movies that the user would want to automatically purchase or rent. Likewise, a user may select one or more Directors, as well as one or more Subject Matter types as a selection criteria for movies.

FIG. 12 also shows that music content may be automatically selected based on Genre types as well as particular Artists, and that games may be automatically purchased or rented based on Subject Matter type and Creator.

Again, the automatic title selection filter criteria shown in FIG. 12 are meant by way of example only. There may be other criteria not shown in FIG. 12 that would be useful for certain types of digital content.

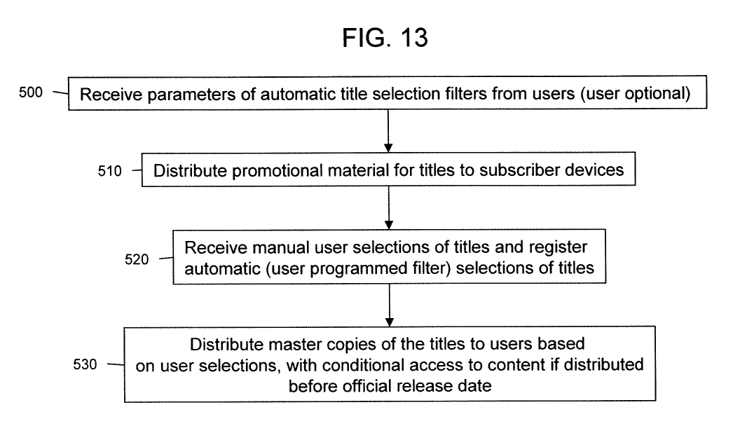

Turning now to FIG. 13, operations of the data center 20 in distributing titles is now described. At 500, the data center receives from subscriber devices parameters for automatic title selection filters made by a user. The data center 20 stores the title selection filter parameters for each user so that the data center 20 can deliver the descrambling code to the appropriate subscriber devices when distribution of the title begins. At 510, the data center 20 distributes promotional material for titles to subscriber devices. The data center 20 distributes the promotional material (e.g., movie trailers) as soon as they are made available to the data center. As mentioned above, this is typically long before the title itself is released. As new titles are being produced, the data center 20 will receive new promotional material well in advance of the release of those titles. Thus, the data center 20 will be distributing promotional material for new titles on an ongoing basis. In addition, the promotional material is distributed for different titles can be spread over time.

At 520, the data center receives manual selections of titles from users. This may be in response to promotional material used or viewed by a user, or may be by way of registering (storing an indication) at the data center 20 that a particular title whose promotional material is distributed is one that satisfies the parameters of a user's automatic title selection filter. At 530, the data center 20 distributes master copies of the titles to users based on the user selections (manual or automatic), where the data file for the master copy of the title is protected so as to prevent access by a user to the data file before the official release date of the title (if the title is in fact distributed to a user before the official release date of the title). Since the release of titles (movies, games, music, etc.) occurs on an ongoing basis, the data center 20 may be in different phases of the distribution model depicted in FIG. 4 for different titles. Consequently, the data center 20 can balance the load of distributing titles to users by spreading that task over time.

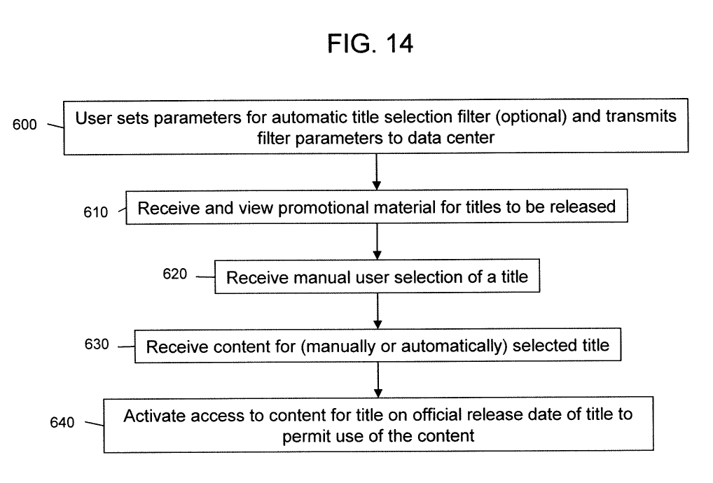

FIG. 14 illustrates an example of a flow chart that depicts the operations of a subscriber device in connection with the distribution techniques described herein. At 600, a user of a subscriber device sets parameters for the automatic title selection filter and the subscriber device transmits this information to the data center 20. The filter programming function at 400 is optional as some users may use it and others may not use it. As mentioned above, a user may program his/her automatic selection filter from a PC by logging into a service provider's web site. At 610, the subscriber device receives promotional material for titles to be released. Again, it is envisioned that the data center 20 will be distributing promotional material to all subscriber devices in the network on a nearly continuous basis for new titles that are in production or close to release. At 620, a user may make a manual selection to purchase or rent a title for which the user's has seen promotional material. At 630, the subscriber device receives and stores the digital data files (content) for any titles selected for purchase or rent by a user, and this may occur well in advance of the official release date of a particular title. Thus, a personal library of titles is built up over time and stored in the subscriber device. At 640, when the official release date arrives, access to the digital data for that title is enabled to permit the user to user the content, e.g., view the movie.

Many of the techniques that are described herein as being useful in a satellite-based distribution network may be used in a distribution network that uses a cable (optical, coaxial, etc.) distribution network.

The above description is intended by way of example only.

What is claimed is:

1. A method comprising:
broadcasting one or more data streams carrying digital data for media content titles to a plurality of subscriber devices;
receiving at a subscriber device the one or more data streams; and
storing in the subscriber device digital data associated with a media content title desired by a subscriber device user without immediately presenting the media content title to the subscriber device user.

2. The method of claim 1, and further comprising following reception by the subscriber device of the one or more data streams, post-processing digital data associated with a media content title to reconstruct one or more missing or lost packets as necessary for storage and subsequent presentation to the subscriber device user.

3. The method of claim 2, and further comprising encoding digital data associated with media content titles into a data stream such that there is correlation among a plurality of packets for a media content title to allow for reconstruction of one or more missing packets of a media content title at a subscriber device.

4. The method of claim 3, wherein post-processing comprises reconstructing at the subscriber device one or more missing packets of digital data for a media content title using other packets of the digital data for the media content title.

5. The method of claim 1, wherein broadcasting comprises broadcasting the one or more data streams at a data rate that is faster than a playout rate at a subscriber device.

6. The method of claim 1, wherein broadcasting comprises broadcasting the one or more data streams from an orbiting satellite transmitter to the plurality of subscriber devices.

7. The method of claim 6, and further comprising changing a modulation scheme and/or error coding rate for a data stream according to changes in reception performance at one or more subscriber devices.

8. The method of claim 7, and further comprising receiving signal reception quality information from one or more subscriber devices indicating quality of reception of one or more data streams at the one or more subscriber devices received from the satellite transmitter, and wherein changing is based on the signal reception quality information.

9. The method of claim 7, wherein changing is further based on one or more of weather forecasts for one or more geographical regions where subscriber devices are located, solar flare prediction data and geographical distribution and density of subscriber devices.

10. The method of claim 1, wherein broadcasting comprises broadcasting digital data representing promotional material for a media content title in advance of an official release date of the media content title.

11. The method of claim 10, wherein broadcasting comprises broadcasting digital data in the one or more data streams for a media content title prior to the official release date of the media content title.

12. The method of claim 11, and further comprising at the official release date, activating access to the media content title in subscriber devices of those users who have purchased or rented rights to the title.

13. An apparatus comprising:
a receiver configured to receive a broadcast signal comprising one or more data streams carrying digital data for media content titles;
a data storage unit configured to store digital data associated with media content titles for presentation to a user; and
a signal processor configured to process data contained in the receive broadcast signal to recover digital data associated with a media content title for storage in the data storage unit without immediately presenting the media content title to the user.

14. The apparatus of claim 13, wherein the signal processor is configured to, following reception of the broadcast signal, post-process digital data associated with a media content title to reconstruct one or more missing or lost packets as necessary for storage and subsequent presentation to the user.

15. The apparatus of claim 14, wherein the signal processor is configured to reconstruct one or more missing packets of digital data for a media content title using other packets of the digital data for the media content title.

16. A system comprising:
a data center configured to generate one or more data streams carrying digital media content tiles for transmission to an orbiting satellite transmitter from which a signal containing the one or more data streams is broadcasted; and
a plurality of subscriber devices each of which is configured to receive the broadcasted signal from the satellite transmitter and to store digital data associated with a media content title desired by a subscriber device user without immediately presenting the media content title to the subscriber device user.

17. The system of claim 16, wherein the data center comprises a processor that is configured to encode digital data associated with media content titles into a data stream such that there is correlation among a plurality of packets for a media content title to allow for reconstruction of one or more missing packets of a media content title at a subscriber device.

18. The system of claim 17, wherein each subscriber device comprises a signal processor that is configured to post-process digital data associated with a media content title to reconstruct one or more missing or lost packets as necessary for storage and subsequent presentation to the subscriber device user.

19. The system of claim 16, wherein the data center is configured to adaptive change a modulation scheme and/or error coding rate for a data stream according to changes in reception performance at one or more subscriber devices.

20. The system of claim 19, wherein one or more subscriber devices is configured to measure signal reception quality of the signal broadcasted from the satellite transmitter and to transmit a signal to the data center containing information representing the signal reception quality, and wherein the data center is configured to change the modulation scheme and/or error coding rate based on the signal quality information receive from one or more subscriber devices.

21. The system of claim 19, wherein the data center is further configured to change the modulation scheme and/or error coding rate based further on one or more of weather forecasts for one or more geographical regions where subscriber devices are located, solar flare prediction data and geographical distribution and density of subscriber devices.
